(19) United States
(12) Patent Application Publication
(10) Pub. No.: US 2012/0288832 A1
(43) Pub. Date: Nov. 15, 2012

(54) Interactive Educational Bingo

(76) Inventor: Maria Christina Mojica, Humble, TX (US)

(21) Appl. No.: 13/466,856

(22) Filed: May 8, 2012

Related U.S. Application Data
(60) Provisional application No. 61/484,953, filed on May 11, 2011.

(51) Int. Cl. G09B 19/22

(52) U.S. Cl. 434/129

(57) ABSTRACT

An interactive educational bingo game system that incorporates historical figures of United States history, potentially in the form of its Presidents, with the classic game of Bingo. Appropriate for children as well as adults, the game may be created for multiple players, individually or in teams. Players may only cover the historical figure on the bingo card if player correctly answers information pertaining to the historical figure.

### CROSS REFERENCE TO RELATED APPLICATIONS

This is a utility application claiming priority to United States Provisional application Ser. No. 61/212,104 filed May 11, 2011, and incorporated herein by reference.

STATEMENT REGARDING FEDERALLY SPONSORED RESEARCH OR DEVELOPMENT

Not Applicable.

### BACKGROUND OF THE INVENTION

1. Field of the Invention.

This invention relates to bingo style game and, more particularly, to an interactive game for providing users with an easy and convenient means of stimulating their minds and honing their thought processes while enjoying a festive Bingo-like game.

2. Description of the Related Art.

Bingo is a popular game of chance. In the game of bingo, a player uses a set of cards with numbers printed on them. The numbers are arranged in five vertical rows, with one row beneath each letter of the word Bingo. A bingo caller shouts out numbers printed on balls that are selected at random from a container. If the number called matches a number on the player's card, the player marks it off. There are several types of bingo games. In one game, for example, players try to match numbers to form vertical, horizontal, or diagonal lines on their card. As soon as the numbers on a card are marked off to form one of these lines, the player stops the game, usually by shouting “Bingo!” If the numbers marked on the card match those called, the player wins a prize. With such odds, it is not uncommon for players to play using numerous cards per game. A fun celebration of camaraderie through high-spirited play, bingo is the world's most popular game. Indeed, it is estimated that there are over 100 million bingo players worldwide, and there are over 50,000 bingo halls in the United States alone. Universally appealing, bingo has become the world's most reliable form of charity fund raising and helps thousands of worthy causes around the world. Not only fun and exciting, research shows that the game of bingo enhances a player's mental speed, observation shills, and memory, helping keep players in peak mental form.

While the traditional game of bingo uses a set of numbers, it has never been used as an interactive game that incorporates United States history, in the form of its Presidents to be played by children as well as adults or played using multiple players, individually or in teams.

Accordingly, a need remains for a bingo style game in order to overcome the above-noted shortcomings. The present invention satisfies such a need by providing an interactive game that is convenient and easy to use, lightweight yet durable in design, versatile in its applications, and designed for providing users with an easy and convenient means of stimulating their minds and honing their thought processes while enjoying a festive Bingo-like game.

### SUMMARY OF THE INVENTION

Interactive educational bingo is a specially designed game that incorporates historical figures with the classic game of Bingo. In one form, the game is designed to be used for United States history with the historical figures comprising Presidents of the United States. It is appropriate for children as well as adults and may be used in educational or entertainment settings. The game may be created for multiple players, individually or in teams.

The game is played using a laminated card, featuring square blocks in a grid formation, with pictures of historical figures in each of the blocks. Each player of the game will have a laminated card. The laminated cards will be randomized as to the order of historical figures within each of the blocks, in other words, no two cards will be identical. Not every card will have all the historical figures on each card, in other words, some cards may feature some historical figures while other cards feature different historical figures.

The game further includes flash cards corresponding to each of the historical figures present on the player cards. Each flash card will have a picture of the historical figure on one side with pertinent biographical information and facts about the historical figure on the other side.

To play the game, a moderator will draw a flash card and show the picture to the players. If the player has the picture of the historical figure, that player must state one correct fact about the historical figure. If the player succeeds, they place a marker over the historical figure on the player's card.

A player wins if he or she has placed markers in a full diagonal, in four corners, in a T or X formation, or in the four middle squares.

In an alternative embodiment, instead of flash cards a book containing pre-identified information about the historical figures and pictures of the historical figures. The moderator would show the players the picture contained in the book.

### DESCRIPTION OF THE DRAWINGS

FIG. 1 discloses the bingo card.

FIG. 2 discloses the marker.

FIG. 3 discloses the front and back of the flash card.

FIG. 4 discloses the winning formations of the bingo card.

### DESCRIPTION OF THE INVENTION

The present invention will now be described more fully hereinafter with reference to the accompanying drawings, in which a preferred embodiment of the invention is shown.

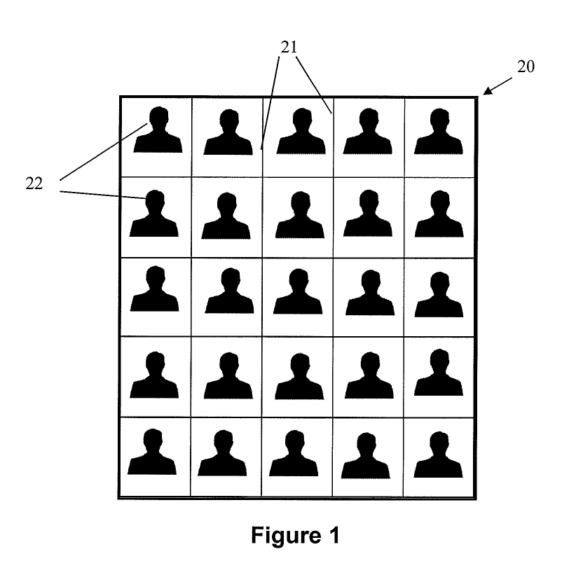

Educational bingo game system 10 is comprised of player cards, flash cards and markers. As shown in FIG. 1, the game includes a bingo card 20. In the preferred embodiment, the bingo card 20 is an eight by ten laminated cardboard sheet. Each bingo card 20 features square blocks 21 arranged in a grid formation. Each block includes a unique identifying mark 22. No two unique identifying marks 22 on a bingo card 20 are the same. The arrangement of the unique identifying mark 22 is randomized so no two bingo cards 20 have the same order of unique identifying marks 22. The unique identifying mark 22 may be an image of a historical figure. In the preferred embodiment, the identifying mark corresponds with images of the Presidents of the United States.

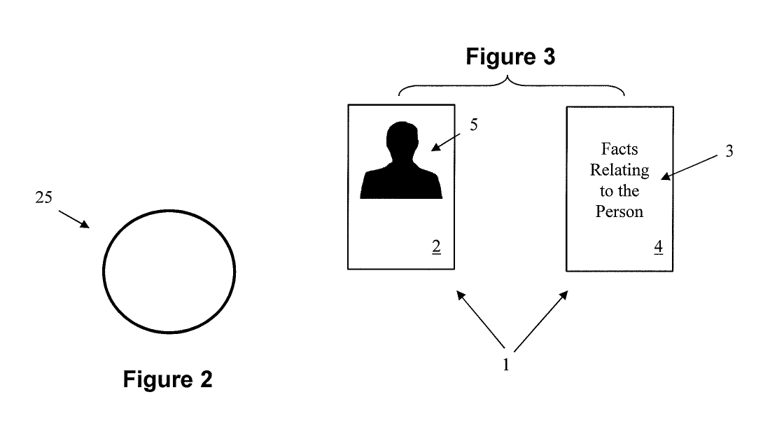

As shown in FIG. 2, a marker 25 is included with the game. The marker is of sufficient size and shape to cover the unique identifying marks 22 but small enough to not exceed the square blocks 21. In the preferred embodiment, players would receive a plurality of markers sufficient to place one marker over every unique identifying mark 22 located on bingo card 20. In the preferred embodiment, the markers 25 would be in the form of multicolored plastic chips.

As shown in FIG. 3, the game includes a flash card 1 comprising a front face 2 and a back face 4. In the preferred embodiment the flash card 1 is laminated. The front face 2 contains a flash card unique identifying mark 5 identical to one of the unique identifying marks 22 located on the bingo card 20. In the preferred embodiment, the flash card unique identifying mark 5 is an image of a President of the United States. On the back face 4 of the flash card 1 is pertinent biographical and factual information 3 corresponding to the flash card unique identifying mark 5. The game includes a plurality of flash cards so that for every unique identifying mark 22 on the bingo card 20, there is a corresponding flash card 1.

In an alternative embodiment, educational bingo game system 10 may utilize a booklet instead of flash cards. In this embodiment, the booklet contains each of the unique identifying marks 22 contained on bingo cards 20 and pertinent biographical and factual information corresponding to each unique identifying mark 22.

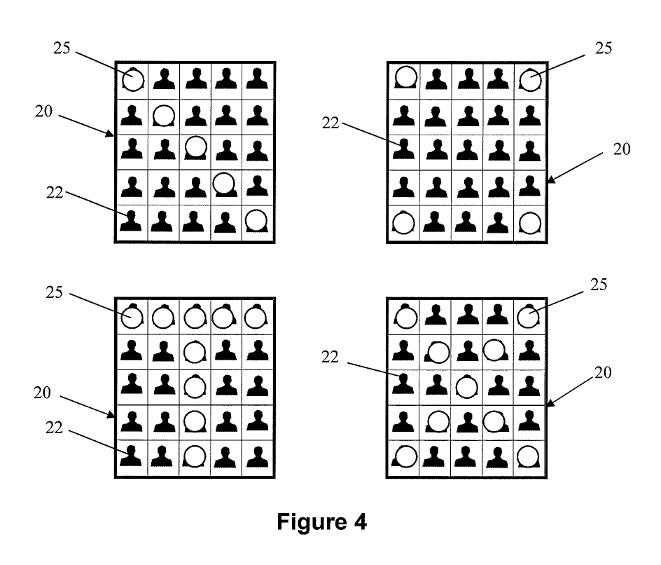

Game play begins with each player obtaining a bingo card 20. The order of unique identifying marks 22 are randomized so no two bingo cards 20 are identical. Furthermore, some unique identifying marks 22 may appear on some bingo cards but not on others. Each bingo card 20 has the same number of unique identifying marks. In the preferred embodiment, a moderator draws a flash card 1 and shows the front face 2 to the players. If a player has a unique identifying mark 22 on the bingo card 20 that is identical to the flash card identifying mark 5, the player must provide accurate details pertaining to the flash card identifying mark 5. This information must correspond to the pertinent biographical and factual information 3 located on the back face 4 of the flash card 1. If the moderator determines the player is correct, the player places a marker 25 over the corresponding unique identifying mark 22 on the bingo card 20. A player wins the game, and may exclaim “Bingo!” if markers are located in a variety of positions on the bingo card 20. As shown in FIG. 4, a player wins if the markers make a full diagonal, are placed in all four corners of the bingo card,, the markers make a “T” formation, the markers make an “X” formation, or markers are placed in the four middle squares (not shown in FIG. 4).

In an alternative embodiment, the unique identifying marks may include famous personalities such as actors, singers or even Nobel Prize winners for the players to select from. The unique identifying mark may be modified to suit the interactive educational or entertainment topic needed to increase learning or enjoyment.

In a non-limiting exemplary embodiment, the interactive educational bingo game system 10 contains minimal components and may be packaged in a compact box set, providing easy storage as well as transport. Not just for household play, interactive educational bingo game system 10 would be an invaluable learning tool that can be used by school teachers to provide fun and interactive civics lessons for students as well as for adults in entertainment settings.

While the invention has been described with respect to certain specific embodiments, it will be appreciated that many modifications and changes may be made by those skilled in the art without departing from the spirit of the invention. It is intended, therefore, by the description hereinabove to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation.

I claim:

1. An apparatus for an interactive educational bingo game comprising
at least one bingo card wherein said bingo card comprises a plurality of unique identifying marks arranged in a grid;
a plurality of flash cards with a front face displaying an identifying mark identical to one of said plurality of unique identifying marks and a back face displaying textual information relating to said identifying mark; and
a marker capable of covering one of said plurality of unique identifying marks arranged in a grid on said bingo card.

2. The apparatus of claim 1 wherein each said bingo card is randomized with respect to arrangement of said plurality of unique identifying marks.

3. The apparatus of claim 1 wherein said bingo card comprises a plurality of unique identifying marks arranged in a grid on both sides of said bingo card.

4. The apparatus of claim 1 wherein said identifying mark comprises an image of a historical figure.

5. The apparatus of claim 1 wherein said identifying mark comprises an image of a President of the United States.

6. The apparatus of claim 1 wherein said plurality of unique identifying marks arranged in a grid are randomized on said bingo card.

7. An apparatus for an interactive educational bingo game comprising
at least one bingo card wherein said bingo card comprises a plurality of unique identifying marks arranged in a grid;
a booklet further comprising:
identifying markings wherein at least one of said identifying markings is identical to one of said plurality of unique identifying marks; and
textual information relating to said identifying markings; and
a marker capable of covering one of said plurality of unique identifying marks arranged in a grid on said bingo card.

8. The apparatus of claim 7 wherein each said bingo card is randomized with respect to arrangement of said plurality of unique identifying marks.

9. The apparatus of claim 7 wherein said bingo card comprises a plurality of unique identifying marks arranged in a grid on both sides of said bingo card.

10. The apparatus of claim 7 wherein said identifying mark comprises an image of a historical figure.

11. The apparatus of claim 7 wherein said identifying mark comprises an image of a President of the United States.

12. The apparatus of claim 7 wherein said plurality of unique identifying marks arranged in a grid are randomized on said bingo card.

13. A method of playing an interactive educational bingo game with a first player, at least one opposing player, and a moderator, using at least two non-identical bingo cards wherein said bingo cards comprise a plurality of unique identifying marks arranged in a grid, a plurality of flash cards with a front face displaying an identifying mark identical to one of said plurality of unique identifying marks and a back face displaying textual information relating to said identifying mark; and a marker capable of covering one of said plurality of unique identifying marks arranged in a grid on said bingo card, the method comprising:
a. said first player obtains first said bingo card;
b. said at least one opposing player obtains second said bingo card;
c. said moderator obtains one of said plurality of flash cards and discloses said front face to said first player and said at least one opposing player;
d. if said first player determines said identifying mark on said one of said plurality of flash cards is identical to one of said plurality of unique identifying marks on said first bingo card and affirmatively identifies textual information on back face of said one of said plurality of flash cards, then said first player places a marker capable of covering said identifying mark on said first bingo card;
e. if said at least one opposing player determines said identifying mark on said one of said plurality of flash cards is identical to one of said plurality of unique identifying marks on said second bingo card and affirmatively identifies textual information on back face of said one of said plurality of flash cards, then said at least one opposing player places a marker capable of covering said identifying mark on said first bingo card; and
f. steps (c) through (e) are repeated until said first bingo card or second bingo card have a formation of said markers consisting of the group comprising of:
a full diagonal across said bingo card;
all four corners of said bingo card;
a “T” formation of said bingo card;
an “X” formation of said bingo card; or
in the four middle squares of said bingo card.

14. The method of claim 13 wherein each said bingo card is randomized with respect to arrangement of said plurality of unique identifying marks.

15. The method of claim 13 wherein said bingo card comprises a plurality of unique identifying marks arranged in a grid on both sides of said bingo card.

16. The method of claim 13 wherein said identifying mark comprises an image of a historical figure.

17. The method of claim 13 wherein said identifying mark comprises an image of a President of the United States.

18. The method of claim 13 wherein said plurality of unique identifying marks arranged in a grid are randomized on said bingo card.
